(19) United States
(12) Patent Application Publication
(10) Pub. No.: US 2008/0062124 A1
(43) Pub. Date: Mar. 13, 2008

(54) MOUSE INTERFACE APPARATUS USING CAMERA, SYSTEM AND METHOD USING THE SAME, AND COMPUTER RECORDABLE MEDIUM FOR IMPLEMENTING THE SAME

(75) Inventors: Jae Hean Kim, Daejeon (KR); Chang Joon Park, Daejeon (KR); Hongseok Kim, Seoul (KR); Jung Jae Yu, Seongnam (KR); Sang Wook Park, Daejeon (KR); Hye Mi Kim, Busan (KR); Jae Kwang Lee, Daejeon (KR); In Ho Lee, Daejeon (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics and Telecommunications Research Institute, Daejeon (KR)

(21) Appl. No.: 11/618,809

(22) Filed: Dec. 30, 2006

(30) Foreign Application Priority Data
Sep. 13, 2006 (KR) 10-2006-0088343

(51) Int. Cl. G09G 5/08

(52) U.S. Cl. 345/157

(57) ABSTRACT

Provided is a mouse interface apparatus using a camera, and system and method using the mouse interface apparatus. The mouse interface apparatus detects image coordinates (xᵢ, yᵢ) of a plurality of points existing on edges of a camera-photographing computer window image from the camera-photographing computer window image, obtains a homography using the detected image coordinates (xᵢ, yᵢ) and plane coordinates (Xi, Yi) of the plurality of preset points on a plane of a real computer window, the homography converting the detected image coordinates (xᵢ, yᵢ) into the plane coordinates (Xi, Yi) on the real computer window, converts an arbitrary coordinate on the camera-photographing image into the plane coordinate on the computer window according to a movement of the camera using the obtained homography, and positions a cursor on the plane coordinate to move the position of the cursor according to the movement of the camera.

### BACKGROUND OF THE INVENTION

1. Field of the Invention

The present invention relates to an interface for controlling the position of a cursor on a computer monitor, and more particularly, to a mouse interface apparatus using a camera that can control a cursor on a real computer window using a homography converting a coordinate system of a camera-photographing computer window image into a plane coordinate system of the real computer window, and system and method using the mouse interface apparatus.

2. Description of the Related Art

In related arts to an interface for controlling a cursor on a computer window, a slope sensor or an accelerator sensor is used to measure a movement or position thereof in a three-dimensional space, thus controlling a mouse or a keyboard. However, since this method needs a complicated sensor device in addition to the computer device, errors are accumulated as the time elapses, and the direction of the sensor may not correspond to the position of the cursor on the computer window.

In another related art interface method, an infrared ray beam is emitted onto a surface of specially devised input device by a specific device to perform a mouse control function and a keyboard input function. This method, however, needs the device for emitting the infrared beam, and the computer monitor and a special additive device for processing the infrared beam as an input information.

In another related art interface method, an infrared sensor or mark is coupled on a user's face and a receiver or a camera is installed on a top of a computer monitor to sense a moving direction of the user's face, thus moving the mouse. In another related art interface method frequently used by a disabled person with the spinal cord injury, the disabled person controls a mouse or keyboard with a stick in his or her mouth. However, this method has a sanitary problem and a difficulty that necessary devices should be attached on a selected portion of a body.

### SUMMARY OF THE INVENTION

Accordingly, the present invention is directed to a mouse interface apparatus using a camera, and system and method using the mouse interface apparatus, which substantially obviate one or more problems due to limitations and disadvantages of the related art.

It is an object of the present invention to provide a mouse interface apparatus using a camera that can control the position of a cursor on a computer window without any additional device except for the camera, and system and method using the mouse interface apparatus.

It is another object of the present invention to provide a mouse interface apparatus using a camera that can control a cursor on a coordinate of a computer monitor so as to be matched with a movement of the camera by in real time obtaining a homography converting a coordinate of a camera-photographing computer window image into a coordinate of a real computer window, and system and method using the mouse interface apparatus.

It is a further another object of the present invention to provide a mouse interface apparatus using a camera that does not need a separate calibration process since a homography according to a real time movement of the camera is obtained, and system and method using the mouse interface apparatus.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided mouse interface apparatus using a camera, comprising: an image coordinate detecting module detecting image coordinates (xᵢ, yⱼ) of a plurality of points existing on edges of a computer window image photographed through a camera from the photographed computer window image; a homography processing module obtaining a homography using the detected image coordinates (xᵢ, yᵢ) and plane coordinates (Xi, Yi) on a plane of a real computer window corresponding to the plurality of preset points; and a cursor coordinate outputting module outputting a coordinate of an arbitrary point on the computer window image photographed by the camera using the homography to determine the output coordinate as a position of a cursor.

The above mouse interface apparatus may further include a mouse driver moving the position of the cursor depending on a variation in the coordinate determined by the cursor coordinate outputting module.

In another aspect of the present invention, there is provided a mouse interface system comprising: a camera continuously photographing a computer window to obtain a camera-photographing computer window image including the computer window; a processor unit obtaining a homography using image coordinates (xᵢ, yⱼ) of a plurality of points existing on edges of the camera-photographing computer window image from the obtained image and plane coordinates (Xi, Yi) on a plane of a real computer window corresponding to the plurality of preset points and obtaining and outputting a coordinate on the real computer window corresponding to an arbitrary coordinate on the camera-photographing image using the obtained homography; and a monitor positioning a cursor on the coordinate outputted by the processor unit to displaying the cursor thereon.

In still another aspect of the present invention, there is provided a mouse interface method using a camera, comprising the steps of: (a) photographing an image of a computer window through a camera; (b) detecting image coordinates of a plurality of points existing on edges of the computer window from the photographed image; (c) obtaining a homography using the detected image coordinates and plane coordinates of a plurality of points on a real computer window; (d) converting an arbitrary point on the image photographed by the camera into a coordinate of the real computer window using the homography to obtain a position of a cursor on a monitor; (e) positioning the cursor at a coordinate of the computer.

At this time, in the mouse interface method, the steps (a)-(e) are continuously repeated according to a variation of the image coordinate according to the movement of the camera.

In yet another aspect of the present invention, there is provided a computer readable recording medium having a program installed to implement functions comprising: an image coordinate detecting function of detecting image coordinates (xᵢ, yᵢ) of a plurality of points existing on edges of a camera-photographing computer window image from the camera-photographing computer window image, the image coordinates (xᵢ, yᵢ) corresponding to positions of the plurality of points on the camera-photographing computer window image; a homography processing function of obtaining a homography using the detected image coordinates (xᵢ, yᵢ) and plane coordinates (Xi, Yi) of the plurality of preset points on a plane of a real computer window; and a cursor coordinate outputting function of obtaining a coordinate of a point on the real computer window corresponding to an arbitrary point on the camera-photographing computer window image to determine a position of a cursor.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a schematic view illustrating a relationship between a camera and a computer window used in an interface according to the present invention;

FIG. 2 is a schematic view illustrating a computer window image photographed by a camera;

FIG. 3 is a schematic view illustrating coordinates of a plurality of points positioned along edges of a real computer window;

FIG. 4 is a schematic view illustrating that a point on a camera-photographing computer window is converted into a point on a real computer window by a homography;

FIG. 5 is a block diagram illustrating a construction of a mouse interface system using a camera according to the present invention;

FIG. 6 is a schematic view illustrating a first embodiment of a mouse interface system using a camera according to the present invention;

FIG. 7 is a schematic view illustrating a second embodiment of a mouse interface system using a camera according to the present invention;

FIG. 8 is a schematic view illustrating a third embodiment of a mouse interface system using a camera according to the present invention; and

FIG. 9 is a flow diagram illustrating a mouse interface method using a camera according to the present invention.

### DETAILED DESCRIPTION OF THE INVENTION

Reference will now be made in detail to the preferred embodiments of the present invention for a mouse interface apparatus using a camera, and system and method using the mouse interface apparatus, examples of which are illustrated in the accompanying drawings.

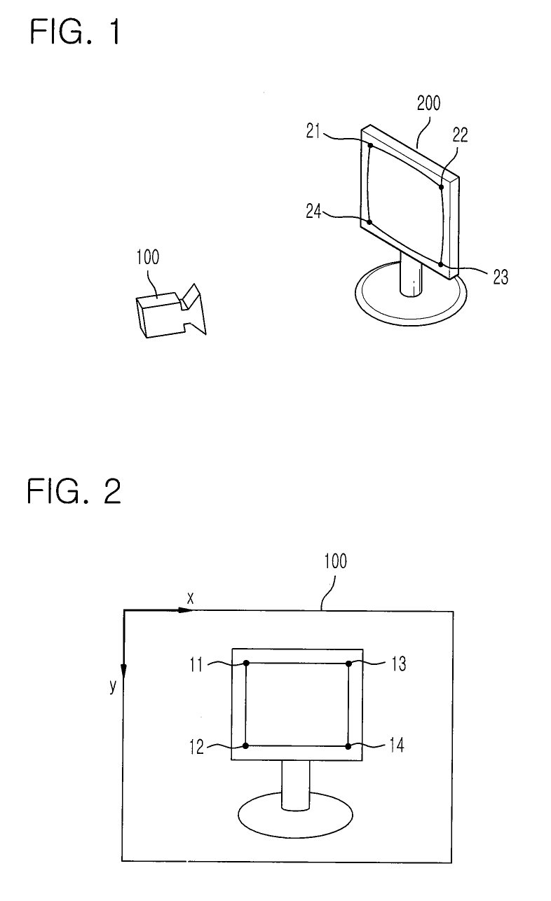

FIG. 1 is a schematic view illustrating a relationship between a camera and a computer window used in an interface according to the present invention.

Referring to FIG. 1, a mouse interface apparatus according to the present invention includes a camera 100 which continuously obtains images of a computer window 200 and detects the positions of a plurality of points 21, 22, 23, 24 positioned along edges of the computer window 200 into a two-dimensional image.

The camera 100 obtains a computer window, i.e., an entire image of a computer monitor as an image. From the image obtained by the camera 100, the positions of a plurality of points positioned along edges of the computer window are detected, and a homography is obtained from a relationship between the positions of the plurality of points obtained by the camera 100 and the positions of the plurality of real points 21, 22, 23, 24 on the computer window. The homography thus obtained functions to convert an image coordinate system (x, y) by the camera 100 into a plane coordinate system (X, Y) by the real computer window 200.

Accordingly, a mouse interface that can control a cursor on the image on the computer monitor can be implemented using the camera 100 and the homography.

Hereinafter, a method for obtaining the homography converting an image coordinate system by the camera into a plane coordinate system (X, Y) by a real computer window will be described with reference to FIGS. 2 through 4.

FIG. 2 is a schematic view illustrating a computer window photographed by a camera.

The camera 100 continuously obtains the image of the computer window 200. The image obtained by the camera 100 includes the computer window 200 itself, but the position of the computer window 200 on the image obtained by the camera 100 is changed depending on a relationship between the camera 100 and the computer window 200, i.e., a movement of the camera 100.

Accordingly, the camera 100 continuously photographs the image of the computer window to obtain the positions of a plurality of points 11, 12, 13, 14 existing along edges of the computer window from the image photographed by the camera 100.

The positions of the plurality of points 11, 12, 13, 14 existing along edges of the computer window are expressed by coordinate values. Here, a coordinate system formed by a plane of the camera-photographing image is referred to as ‘image coordinate system’ and is expressed by (x, y). In the image coordinate system, each coordinate value is expressed by (xᵢ, yᵢ). As shown in FIG. 2, the image coordinate system sets an upper left apex of the image photographed by the camera 100 as an origin, and coordinates for the plurality of points on the camera-photographing computer window image on the basis of the origin can be detected. The obtaining the image coordinate value as above is only one embodiment, and the image coordinate value can be obtained by various methods.

To obtain the homography according to the present invention, the coordinates of the plurality of points 11, 12, 13, 14 existing along the edges of the computer window are detected from the camera-photographing computer window image. The coordinates of the plurality of points 11, 12, 13, 14 existing along the edges of the camera-photographing computer window image can be obtained by an image processing unit built in the camera or obtained by the computer which has received the image photographed by the camera 100.

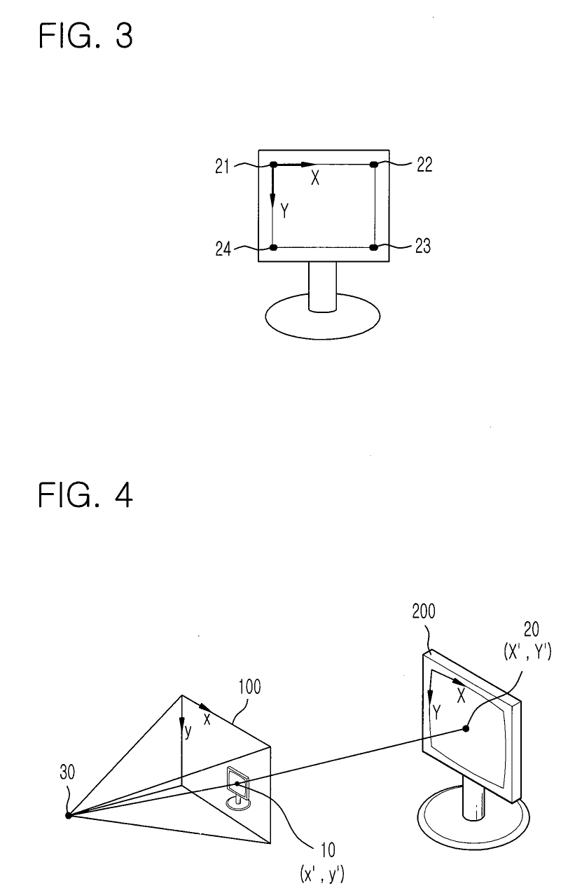

FIG. 3 is a schematic view illustrating coordinates of a plurality of points positioned along edges of a real computer window.

The coordinates of a plurality of points 21, 22, 23, 24 existing along edges of a real computer window are coordinates on a plane constituting the computer window, and exist on a plane coordinate system (X, Y). A coordinate constituting the plane coordinate system (X, Y) is referred to as a plane coordinate and is expressed by (Xi, Yi).

The homography indicates a relationship between the image coordinate (x, y) that is the position on the camera-photographing computer window image and the plane coordinate (X, Y) that is the position on the real computer window. To obtain the homography, the plane coordinates of the plurality of points 21, 22, 23, 24 on the edges of the real computer window corresponding to the plurality of points 11, 12, 13, 14 on the edges of the camera-photographing computer window image as shown in FIG. 2 are obtained.

The plane coordinate (X, Y) is a plane made by the computer window, and the coordinates of the plurality of points can be obtained with the upper left apex of the computer window set as an origin. The position of the origin may be changed.

The coordinate values of the plurality of points on the edges of the computer window are preset and stored by a user. Therefore, the positions of the plurality of points on the edges of the computer window have to correspond to the positions of the plurality of points on the edges of the camera-photographing computer window image.

Next, the homography converting the image coordinate system (x, y) into the plane coordinate system (X, Y) using the image coordinate (xᵢ, yᵢ) detected with respect to the plurality of same points on the edges of the computer window and the preset plane coordinate (Xi, Yi) can be obtained as follows.

The homography using the image coordinate (xᵢ, yᵢ) (where i=1, . . . N) detected with respect to the plurality of points and the preset plane coordinate (Xi, Yi) (where i=1, . . . N) has a 3*3 matrix as follows:

$$H = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ]$$

At this time, an equation to obtain the homography is as follows.

$$\begin{matrix}A \\ [ \begin{matrix}{x}_{1} & {y}_{1} & 1 & 0 & 0 & 0 & - {x}_{1} {X}_{1} & - {y}_{1} {X}_{1} & - {X}_{1} \\ 0 & 0 & 0 & {x}_{1} & {y}_{1} & 1 & - {x}_{1} {X}_{1} & - {y}_{1} {X}_{1} & - {Y}_{1} \\ & & & & ⋮ & & & & \\ {x}_{N} & {y}_{N} & 1 & 0 & 0 & 0 & - {x}_{N} {X}_{N} & - {y}_{N} {X}_{N} & - {X}_{N} \\ 0 & 0 & 0 & {x}_{N} & {y}_{N} & 1 & - {x}_{N} {X}_{N} & - {y}_{N} {X}_{N} & - {Y}_{N}\end{matrix} ]\end{matrix} \begin{matrix}h \\ [ \begin{matrix}{h}_{11} \\ {h}_{12} \\ {h}_{13} \\ {h}_{21} \\ {h}_{22} \\ {h}_{23} \\ {h}_{31} \\ {h}_{32} \\ {h}_{33}\end{matrix} ]\end{matrix} = 0$$

When a singular value decomposition of the matrix A is performed in the above equation, a singular vector corresponding to the smallest singular value becomes a solution h. The solution can be obtained by detecting at least four points without needing to detect all N points from the camera-photographing computer window image.

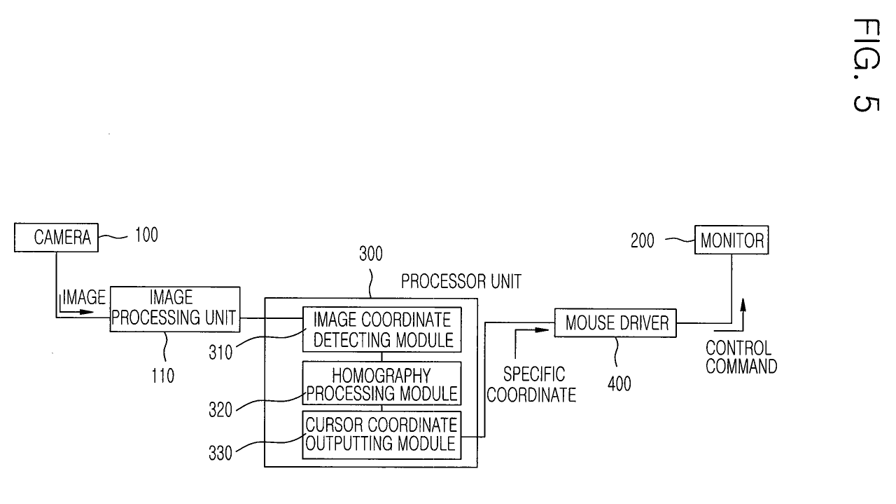

The coordinate of a point on the real computer window corresponding to a point on the camera-photographing computer window will be described with reference to FIG. 4.

FIG. 4 is a schematic view illustrating that a point on the computer window photographed by the camera is converted into a point on the real computer window using a homography.

To converter a point (x′, y′) on the computer window photographed by the camera into a point (X′, Y′) on the real computer window using a homography, a user first has to set the point (x′, y′) on the camera-photographing computer window. Since the point (x′, y′) on the camera-photographing computer window is based on the image coordinate (x, y) obtained by the camera, it can be converted into a specific coordinate (X′, Y′) on the real computer window by a below equation using a homography.

$${X}^{′} = \frac{{h}_{11} {x}^{′} + {h}_{12} {y}^{′} + {h}_{13}}{{h}_{31} {x}^{′} + {h}_{32} {y}^{′} + {h}_{33}} {Y}^{′} = \frac{{h}_{21} {x}^{′} + {h}_{22} {y}^{′} + {h}_{23}}{{h}_{31} {x}^{′} + {h}_{32} {y}^{′} + {h}_{33}}$$

The specific coordinate (X′, Y′) on the real computer window is calculated on the basis of the plane coordinate system (X, Y) by the computer window, and indicates a point where a straight line connecting a focus 30 with the point (x′, y′) on the computer window set by the user meets with the plane coordinate system (X, Y) by the computer window. If a mouse cursor is placed on the position of the node thus calculated, it is possible to control the movement of the mouse cursor according to the position of the straight line connecting the focus 30 with the point (x′, y′) on the computer window by adjusting the direction and position of the camera.

In the case of adjusting the direction and position of the camera, since the position of the computer window projected on the image photographed by the camera is changed and accordingly the image coordinates (xi, yi) of the plurality of points 11, 12, 13, 14 are also changed, the homography is continuously obtained. Since the specific coordinate (X′, Y′) of the plane coordinate system where the mouse cursor with respect to the arbitrary point (x′, y′) on the camera-photographing computer window is positioned is changed according to the continuously obtained homography, the cursor is also moved correspondingly according to a movement of the camera.

FIG. 5 is a block diagram illustrating a construction of a mouse interface system using a camera according to the present invention.

Referring to FIG. 5, a mouse interface system using a camera includes the camera 100 photographing an image including a computer window, an image processing unit 110 detecting coordinates of a plurality of points existing along edges of the computer window from the photographed image, a processor unit 300 obtaining a homography using the coordinates of the plurality of points detected and plane coordinates by a computer window of a plurality of points preset by a user and obtaining and outputting a coordinate where a mouse cursor is being positioned using the obtained homography and an arbitrary point on the image photographed by the camera 100, a mouse driver 400 changing the position of the mouse cursor according to a change of the output coordinate, and a monitor 200 displaying the mouse cursor at a position of the output coordinate on the computer window.

The camera 100 can freely move according to a control of the user. The camera 100 can be provided therein with the image processing unit 110. That is, the camera 100 can detect and output image coordinates of a plurality of points from the photographed image.

The image processing unit 110 is provided in the camera 100, or the processor unit 300 may also perform the function for detecting the image coordinate of the image processing unit 110.

The processor unit 300 is configured to include an image coordinate detecting module 310, a homography processing module 320, and a cursor coordinate output module 330.

The image coordinate detecting module 310 detects the image coordinates (xi, yi) of the plurality of points from the image photographed by the camera 100.

The homography processing module 320 obtains a homography using the detected image coordinate (xᵢ, yᵢ) and the plane coordinate (Xi, Yi) of the plurality of points preset on the computer window. Since the image coordinate (xᵢ, yᵢ) is changed with the movement of the camera 100, the homography is continuously obtained.

The cursor coordinate output module 330 outputs the coordinate (X′, Y′) on the computer window corresponding to the arbitrary point (x′, y′) on the image photographed by the camera using the continuously obtained homography and selects the output coordinate as a position of the cursor.

The mouse driver 400 adjusts the movement of the mouse cursor according to the movement of the coordinate (X′, Y′) on the computer window selected as the position of the cursor.

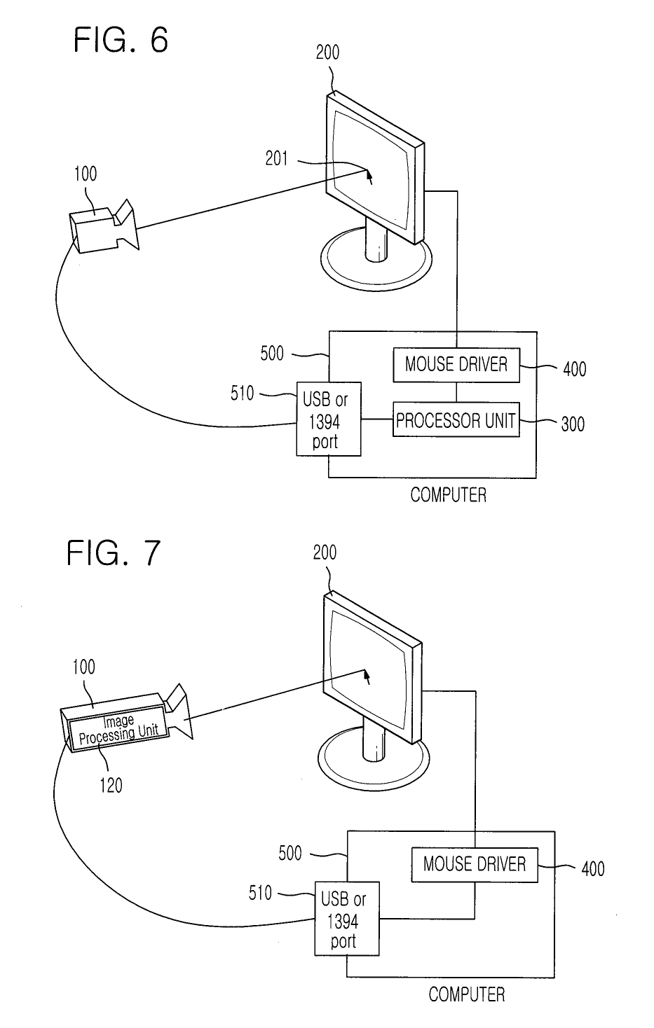

FIG. 6 is a schematic view illustrating a first embodiment of a mouse interface system using a camera according to the present invention.

Referring to FIG. 6, a camera 100 for photographing an image including a computer window may be one of a variety of cameras, for example, a USB camera or 1394 camera. The camera 100 photographs an image and transmits the same to a computer 500. The camera 100 and the computer 500 transmit and receive the image through a USB port or 1394 port 510.

The computer 500 includes a processor unit 300 which detects image coordinates corresponding to a plurality of points on edges of a computer window from the image transmitted by the camera 100, obtains a homography using the detected image coordinates and real plane coordinates, and converts an arbitrary point on the image coordinate into a specific coordinate on the computer window using the homography to determine and output a position of a mouse cursor.

The processor unit 300 can perform its function using an execution program which is installed in the computer 500 to receive and process the image photographed by the camera 100.

A mouse driver 400 for positioning a mouse cursor 201 at the position of the mouse cursor outputted by the processor unit 300 and displaying the cursor 201 using a monitor 200 is installed in the computer 500.

Accordingly, the monitor 200 displays the mouse cursor 201 using the homography obtained according to a movement of the camera 100.

FIG. 7 is a schematic view illustrating a second embodiment of a mouse interface system using a camera according to the present invention.

A camera 100 shown in FIG. 7 photographs an image including a computer window, and it includes an image processing unit 120 which detects image coordinates corresponding to a plurality of points on edges of a computer window from the image photographed by the camera 100, obtains a homography, obtains a positional coordinate of a mouse cursor using the obtained nomography, and transmits the obtained positional coordinate to a computer 500.

The image processing unit 120 performs the same functions as those of the processor unit 300 built in the computer shown in FIG. 5. That is, the image processing unit 120 obtains a homography using the image coordinate detected from the photographed image and a real plane coordinate, converts an arbitrary point on the image coordinate into a specific coordinate on the computer window using the homography to determine and output a position of a mouse cursor.

The camera 100 transmits a coordinate value on the position of the mouse cursor outputted by the image processing unit 120 to the computer 500. At this time, the camera 100 and the computer 500 transmit and receive a signal on the coordinate value through a USB port or 1394 port 510.

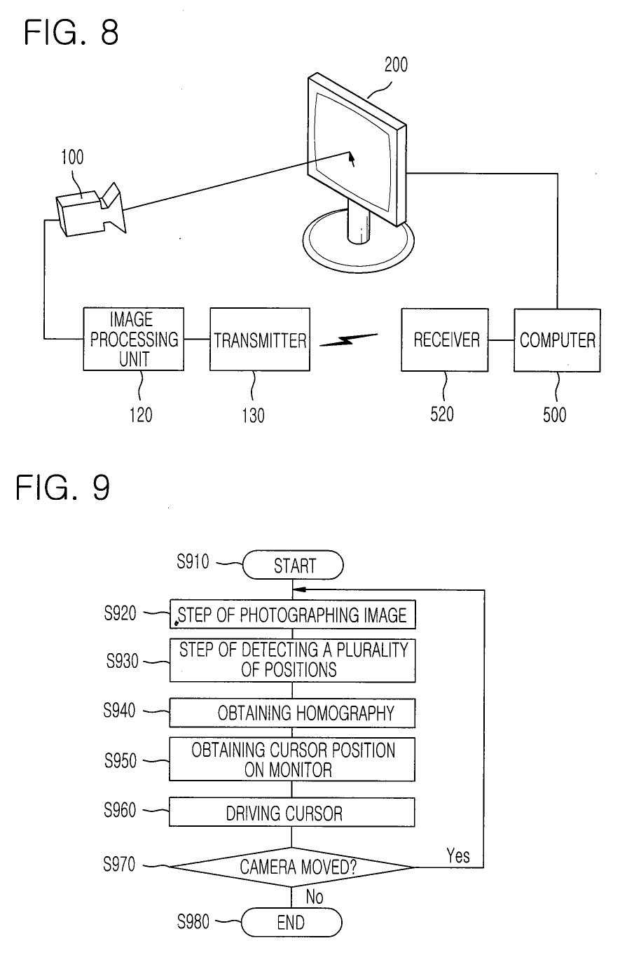

FIG. 8 is a schematic view illustrating a third embodiment of a mouse interface system using a camera according to the present invention.

Referring to FIG. 8, a camera 100 wirelessly communicates with a computer 500. Accordingly, the camera 100 transmits a photographed image or a coordinate value of a mouse cursor processed by an image processing unit 120 through a transmitter 130. The computer 500 receives the image photographed by the camera 100 or the coordinate value of the mouse cursor through a receiver 520 to control a position of a cursor on a monitor 200.

FIG. 9 is a flow diagram illustrating a mouse interface method using a camera according to the present invention.

Referring to FIG. 9, a mouse interface method using a camera includes the steps of: photographing an image of a computer window through a camera (S920); detecting image coordinates of a plurality of points existing on edges of the computer window from the photographed image (S930); obtaining a homography using the detected image coordinates and plane coordinates of a plurality of points on a real computer window (S940); converting an arbitrary point on the image photographed by the camera into a coordinate of the real computer window using the homography to obtain a position of a cursor on a monitor (S950); positioning the cursor at a coordinate of the computer window and adjusting a motion of the cursor to drive the cursor (S960); and determining whether or not the camera has a movement (S970). In the determining step (S970), when it is determined that the camera has a movement, the flow again returns to the photographing step (S920). Accordingly, it is possible to continue to adjust the position of the mouse cursor depending on the movement of the camera.

Although not shown in the drawings, in another embodiment of the present invention, a computer readable recording medium in which a program is installed may be provided to implement functions of the present invention. The computer readable recording medium for implementing an interfacing function using a camera according to the present invention is characterized by including an image coordinate detecting function of detecting image coordinates (xᵢ, yᵢ) of a plurality of points existing on edges of a computer window photographed by a camera; a homography processing function of obtaining a homography using the detected image coordinates (xᵢ, yᵢ) and plane coordinates (Xi, Yi) on a plane of a real computer window corresponding to the plurality of preset points; and a cursor coordinate outputting function of obtaining a coordinate of an arbitrary point on the computer window image photographed by the camera using the homography to determine a position of a cursor.

Also, the present invention can further implement a function of moving the position of the cursor according to a variation in the coordinate determined by the cursor coordinate outputting function.

As described above, the mouse interface apparatus, and system and method using the apparatus according to the present invention can establish an interface system using a camera connected to a computer, at a low cost without needing a calibration prior to its use and a separate interface apparatus.

Also, the present invention enables a disabled person with the spinal cord injury who wears the mouse interface apparatus of the present invention on his or her head, to use a computer, or to utilize the mouse interface apparatus as an interface in using a general computer, a computer game, or a presentation.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A mouse interface apparatus using a camera, comprising:
an image coordinate detecting module detecting image coordinates (xᵢ, yᵢ) of a plurality of points existing on edges of a computer window from the computer window image obtained through a camera;
a homography processing module obtaining a homography using the detected image coordinates (xᵢ, yᵢ) and plane coordinates (Xi, Yi) on a plane of a real computer window; and
a cursor coordinate outputting module outputting a plane coordinate of an arbitrary point on the computer window image using the nomography to determine the output coordinate as a position of a cursor.

2. The mouse interface apparatus of claim 1, further comprising a mouse driver moving the position of the cursor depending on a variation in the plane coordinate determined by the cursor coordinate outputting module.

3. The mouse interface apparatus of claim 1, wherein the plurality of points are comprised of at least four points existing on the edges of the computer window.

4. The mouse interface apparatus of claim 1, wherein the homography is comprised of a 3*3 matrix converting the image coordinates (xᵢ, yᵢ) into the plane coordinates (Xi, Yi).

5. The mouse interface apparatus of claim 4, wherein the homography is H obtained by a below equation
$$\begin{matrix}A \\ [ \begin{matrix}{x}_{1} & {y}_{1} & 1 & 0 & 0 & 0 & - {x}_{1} {X}_{1} & - {y}_{1} {X}_{1} & - {X}_{1} \\ 0 & 0 & 0 & {x}_{1} & {y}_{1} & 1 & - {x}_{1} {X}_{1} & - {y}_{1} {X}_{1} & - {Y}_{1} \\ & & & & ⋮ & & & & \\ {x}_{N} & {y}_{N} & 1 & 0 & 0 & 0 & - {x}_{N} {X}_{N} & - {y}_{N} {X}_{N} & - {X}_{N} \\ 0 & 0 & 0 & {x}_{N} & {y}_{N} & 1 & - {x}_{N} {X}_{N} & - {y}_{N} {X}_{N} & - {Y}_{N}\end{matrix} ]\end{matrix} \begin{matrix}h \\ [ \begin{matrix}{h}_{11} \\ {h}_{12} \\ {h}_{13} \\ {h}_{21} \\ {h}_{22} \\ {h}_{23} \\ {h}_{31} \\ {h}_{32} \\ {h}_{33}\end{matrix} ]\end{matrix} = 0$$

6. The mouse interface apparatus of claim 1, wherein the homography processing module continues to obtain a homography according to a variation in the image coordinates (xᵢ, yᵢ).

7. A mouse interface system comprising:
a camera continuously photographing a computer window to obtain a camera-photographing computer window image including the computer window;
a processor unit obtaining a homography using image coordinates (xᵢ, yᵢ) of a plurality of points existing on edges of the camera-photographing computer window image from the obtained image and plane coordinates (Xi, Yi) on a plane of a real computer window corresponding to the plurality of preset points and obtaining and outputting a coordinate on the real computer window corresponding to an arbitrary coordinate on the camera-photographing image using the obtained nomography; and
a monitor positioning a cursor on the coordinate outputted by the processor unit to displaying the cursor thereon.

8. The mouse interface system of claim 7, wherein the homography converts the image coordinates into the plane coordinates on the computer window.

9. The mouse interface system of claim 8, wherein the processor unit continues to obtain the homography if the image coordinates (xᵢ, yᵢ) are changed by a movement of the camera.

10. The mouse interface system of claim 9, wherein the processor unit continues to obtain the coordinate on the real computer window corresponding to the arbitrary coordinate on the camera-photographing image according to the continuously obtained homography.

11. The mouse interface system of claim 10, wherein the processor unit further comprises a mouse driver for moving the position of the cursor displayed on the monitor according to a change in the output coordinate.

12. The mouse interface system of any of claims 7 to 11, wherein the plurality of points on the edges of the computer window are at least four.

13. A mouse interface system comprising:
a camera continuously which photographs a computer window to obtain an image including the computer window, obtains a homography using image coordinates (xᵢ, yᵢ) of a plurality of points existing on edges of the camera-photographing computer window image from the obtained image and plane coordinates (Xi, Yi) on a plane of a real computer window corresponding to the plurality of preset points, obtains and outputs a coordinate on the real computer window corresponding to an arbitrary coordinate on the camera-photographing image using the obtained nomography.

14. The mouse interface system of claim 13, further comprising a mouse driver for controlling the camera such that the cursor is positioned at a position corresponding to the coordinate outputted from the camera on the computer window monitor.

15. The mouse interface system of claim 14, wherein the camera and the mouse driver wireless transmit and receive a signal on the coordinate outputted from the camera.

16. The mouse interface system of claim 14, wherein the camera and the mouse driver are connected by a USB port.

17. A mouse interface system comprising:
a camera continuously which photographs a computer window to obtain an image including the computer window; and
a computer including a processor unit which obtains a homography using image coordinates (xᵢ, yᵢ) of a plurality of points existing on edges of the camera-photographing computer window image from the obtained image and plane coordinates (Xi, Yi) on a plane of a real computer window corresponding to the plurality of preset points, obtains and outputs a coordinate on the real computer window corresponding to an arbitrary coordinate on the camera-photographing image using the obtained homography.

18. The mouse interface system of claim 17, wherein the camera comprises an image processing unit detecting the image coordinates (xᵢ, yᵢ) which are positions of the plurality of points existing on the edges of the camera-photographing computer window image from the obtained image on the camera-photographing image.

19. The mouse interface system of claim 17, wherein the computer comprises a mouse driver for controlling the computer such that the cursor is positioned at a position corresponding to the coordinate outputted from the camera on the computer window monitor.

20. The mouse interface system of any of claims 17 to 19, wherein the plurality of points are at least four points on the edges of the computer window.

21. The mouse interface system of claim 20, wherein the camera and the computer wireless transmit and receive a signal outputted from the camera.

22. The mouse interface system of claim 20, wherein the camera and the computer are connected by a USB port.

23. The mouse interface system of claim 21, wherein the homography is continuously varied according to a movement of the camera.

24. A mouse interface method using a camera comprising the steps of:
(a) photographing an image of a computer window through a camera;
(b) detecting image coordinates of a plurality of points existing on edges of the computer window from the photographed image;
(c) obtaining a homography using the detected image coordinates and plane coordinates of a plurality of points on a real computer window;
(d) converting an arbitrary point on the image photographed by the camera into a coordinate of the real computer window using the homography to obtain a position of a cursor on a monitor;
(e) positioning the cursor at a coordinate of the computer.

25. The mouse interface method of claim 24, wherein the plurality of points are at least four.

26. The mouse interface method of claim 25, wherein the homography is comprised of a 3*3 matrix converting the image coordinates (xᵢ, yᵢ) into the plane coordinates (Xi, Yi).

27. The mouse interface method of claim 26, wherein the homography is H obtained by a below equation
$$\begin{matrix}A \\ [ \begin{matrix}{x}_{1} & {y}_{1} & 1 & 0 & 0 & 0 & - {x}_{1} {X}_{1} & - {y}_{1} {X}_{1} & - {X}_{1} \\ 0 & 0 & 0 & {x}_{1} & {y}_{1} & 1 & - {x}_{1} {X}_{1} & - {y}_{1} {X}_{1} & - {Y}_{1} \\ & & & & ⋮ & & & & \\ {x}_{N} & {y}_{N} & 1 & 0 & 0 & 0 & - {x}_{N} {X}_{N} & - {y}_{N} {X}_{N} & - {X}_{N} \\ 0 & 0 & 0 & {x}_{N} & {y}_{N} & 1 & - {x}_{N} {X}_{N} & - {y}_{N} {X}_{N} & - {Y}_{N}\end{matrix} ]\end{matrix} \begin{matrix}h \\ [ \begin{matrix}{h}_{11} \\ {h}_{12} \\ {h}_{13} \\ {h}_{21} \\ {h}_{22} \\ {h}_{23} \\ {h}_{31} \\ {h}_{32} \\ {h}_{33}\end{matrix} ]\end{matrix} = 0$$

28. The mouse interface method of any of claims 24 to 27, wherein the steps (a)-(e) are continuously repeated according to a variation of the image coordinate according to the movement of the camera.

29. A computer readable recording medium having a program installed to implement functions comprising:
an image coordinate detecting function of detecting image coordinates (xᵢ, yᵢ) of a plurality of points existing on edges of a camera-photographing computer window image from the camera-photographing computer window image, the image coordinates (xᵢ, yᵢ) corresponding to positions of the plurality of points on the camera-photographing computer window image;
a homography processing function of obtaining a homography using the detected image coordinates (xᵢ, yᵢ) and plane coordinates (Xi, Yi) of the plurality of preset points on a plane of a real computer window; and
a cursor coordinate outputting function of obtaining a coordinate of a point on the real computer window corresponding to an arbitrary point on the camera-photographing computer window image to determine a position of a cursor.

30. The computer readable recording medium of claim 29, wherein the program further comprises a function of moving the position of the cursor according to a change in the coordinate determined by the cursor coordinate outputting function.

31. The computer readable recording medium of claim 30, wherein the homography processing function is to implement a function of continuously obtaining the homography according to a change in the image coordinates (xᵢ, yᵢ).

32. The computer readable recording medium of claim 31, wherein the homography processing function is to implement a 3*3 matrix converting the image coordinates (xᵢ, yᵢ) into the plan9e coordinates (Xi, Yi).

33. The computer readable recording medium of claim 32, wherein the plurality of points are at least four points existing on the edges of the computer window.
